(19) United States
(12) Patent Application Publication
(10) Pub. No.: US 2017/0129523 A1
(43) Pub. Date: May 11, 2017

(54) HANDCART

(71) Applicant: Murata Manufacturing Co., Ltd., Kyoto (JP)

(72) Inventors: Yoshitaka Hane, Kyoto (JP); Kenichi Shirato, Kyoto (JP)

(21) Appl. No.: 15/409,886

(22) Filed: Jan. 19, 2017

Related U.S. Application Data
(63) Continuation of application No. PCT/JP2015/070639, filed on Jul. 21, 2015.

(30) Foreign Application Priority Data
Jul. 23, 2014 (JP) 2014-149397
Dec. 16, 2014 (JP) 2014-253790

(51) Int. Cl. B62B 5/04; B62B 3/04; B62B 5/00; B62B 5/06

(52) U.S. Cl. CPC B62B 5/0414; B62B 5/06; B62B 3/04; B62B 5/0033

(57) ABSTRACT

A handcart (includes a main body unit, a pair of main wheels provided to the main body unit, a grip unit that is provided to the main body unit and gripped by a user, a grip switch that detects whether the user is gripping the grip unit, a tilt angle sensor, a camera, an acceleration sensor, or other devices that detect the state of the cart body, and a wheel lock mechanism that locks the main wheels if the grip switch does not detect user's gripping of the grip unit and if the cart body is in a predetermined state, for example, if it is detected by the acceleration sensor or other devices that the cart body is moving. This configuration provides a handcart that locks the wheels without necessarily compromising usability.

This is a continuation of International Application No. PCT/JP2015/070639 filed on Jul. 21, 2015 which claims priority from Japanese Patent Application No. 2014-253790 filed on Dec. 16, 2014 and Japanese Patent Application No. 2014-149397 filed on Jul. 23, 2014. The contents of these applications are incorporated herein by reference in their entireties.

### BACKGROUND

### Technical Field

The present disclosure relates to a handcart that assists the user in walking.

Handcarts used to assist users such as elderly and handicapped people in walking are known. For example, Patent Document 1 discloses a walker with a pair of wheels attached to the main body unit, the pair of wheels being rotated by an electric motor or other devices. When the user moves this walker in the direction of travel, the wheels of the walker are rotated by the electric motor or other devices to assist the user in walking.
Patent Document 1: International Publication No. 2012/114597

### BRIEF SUMMARY

Handcarts are equipped with the function of locking the rotation of the wheels. Typically, this lock operation is performed manually by the user. The problem with manual lock operation, however, is that the user may forget to perform such a lock operation. One way to address this problem would be to cause the wheels to be locked automatically when the user takes the hands off the grip unit of the handcart.

However, if simply taking the hands off the grip unit of the handcart causes the wheels to be locked, this may decrease usability when the user wants to move the cart body without gripping the grip unit, for example, when the user wants to perform an operation such as changing the direction of the cart body. Another way would be to cause the wheels to be locked after elapse of a predetermined time. However, this means that the wheels are locked when the handcart is simply at rest with the user's hands taken off, resulting in decreased usability for the user.

Accordingly, the present disclosure provides a handcart that can be used safely without necessarily compromising usability.

A handcart according to the present disclosure includes a main body unit, at least one wheel provided to the main body unit, a grip unit that is provided to the main body unit and gripped by a user, a gripping detector/sensor that detects whether the user is gripping the grip unit, a cart body state detector/sensor that detects the state of the cart body, and a wheel controller that controls rotation of the wheel. The wheel controller locks the wheel, or restrains rotation of the wheel to decelerate the cart body, if the gripping detector does not detect user's gripping of the grip unit and the cart body state detector detects a predetermined cart body state.

According to this configuration, rather than locking the wheel or restraining rotation of the wheel based solely on the condition that the user is not gripping the grip unit, the wheel is locked or rotation of the wheel is restrained also by taking the state of the cart body into consideration. Restraining rotation of the wheel allows the cart body to decelerate while moving. For example, the wheel is locked or rotation of the wheel is restrained when the grip unit is not being gripped and the cart body is moving at a speed equal to or greater than a predetermined value. This prevents the wheel from being locked or prevents rotation of the wheel from being restrained the moment the user takes the hands off the grip unit. This prevents the wheel from being locked or prevents rotation of the wheel from being restrained against user's intention, and also saves the user the trouble of releasing the lock on the wheel or the restraint on rotation of the wheel. This makes it possible to achieve a handcart that has the function of locking the wheel or restraining rotation of the wheel without necessarily compromising usability.

The handcart according to the present disclosure can be configured such that the predetermined cart body state represents movement of the cart body, the cart body state detector detects movement of the cart body, and the wheel controller locks the wheel or restrains rotation of the wheel if the amount of movement detected by the cart body state detector exceeds a predetermined value.

According to this configuration, when the user takes the hands off the grip unit and the handcart starts to move on its own, the wheel is locked or rotation of the wheel is restrained. This prevents accidents that can occur when the handcart starts to move on its own.

The handcart according to the present disclosure can be configured such that if the cart body state detector detects movement of the cart body, the wheel controller locks the wheel after restraining rotation of the wheel.

According to this configuration, the cart body is decelerated before the wheel is locked. This prevents the handcart from falling over due to inertia when the wheel is suddenly locked.

The handcart according to the present disclosure can be configured such that the cart body state detector detects the acceleration of the cart body, and the wheel controller locks the wheel or restrains rotation of the wheel if the acceleration detected by the cart body state detector is equal to or greater than a predetermined value.

According to this configuration, the wheel is locked or rotation of the wheel is restrained when the cart body suddenly moves. This prevents potential accidents.

The handcart according to the present disclosure can be configured such that the cart body state detector detects the speed of the cart body, and the wheel controller locks the wheel or restrains rotation of the wheel if the speed detected by the cart body state detector is equal to or greater than a predetermined value.

If only the slightest movement of the cart body causes the wheel to be locked or causes rotation of the wheel to be restrained, the user needs to take the trouble of releasing the lock or restraint. Accordingly, the wheel is locked or rotation of the wheel is restrained not when the cart body has moved only slightly but when the cart body has definitely moved at a speed exceeding a certain speed. This saves trouble for the user without necessarily compromising usability.

The handcart according to the present disclosure can be configured such that the cart body state detector detects the distance moved by the cart body, and the wheel controller locks the wheel or restrains rotation of the wheel if the distance moved detected by the cart body state detector is equal to or greater than a predetermined value.

If only the slightest movement of the cart body causes the wheel to be locked or causes rotation of the wheel to be restrained, the user needs to take the trouble of releasing the lock or restraint. Accordingly, the wheel is locked or rotation of the wheel is restrained not when the cart body has moved only slightly but when the cart body has definitely moved a certain distance or more. This saves trouble for the user without compromising usability.

The handcart according to the present disclosure can be configured such that the at least one wheel includes a pair of wheels, the cart body state detector calculates the difference in the amount of rotation between the wheels, and if the difference exceeds a threshold, the wheel controller locks the wheels or restrains rotation of the wheels.

According to this configuration, whether the cart body has turned on the spot or has moved forward or rearward can be determined from the difference in the amount of rotation between the pair of wheels. If the cart body is determined to have moved forward or rearward, the wheels are locked or rotation of the wheels is restrained. The amount of rotation in this case represents the rotation speed of the wheels, the distance moved by the wheels, or other values. This prevents the wheels from being locked or prevents rotation of the wheels from being restrained when the cart body is turned on the spot to change the direction of the handcart, thus avoiding a decrease in usability for the user.

The handcart according to the present disclosure can be configured such that the cart body state detector detects the tilt angle of the cart body, and the wheel controller locks the wheel or restrains rotation of the wheel if the tilt angle detected by the cart body state detector is equal to or greater than a predetermined value.

According to this configuration, when the handcart is placed on a slope, the wheel is locked or rotation of the wheel is restrained. This prevents accidents that can occur when the handcart starts to move on its own.

The handcart according to the present disclosure can be configured such that the cart body state detector includes an imaging unit that captures an image of the surroundings, the cart body state detector detects the situation in the surroundings of the cart body based on the image of the surroundings captured by the imaging unit, and the wheel controller locks the wheel or restrains rotation of the wheel if the cart body state detector detects a predetermined situation in the surroundings of the cart body.

For example, when the handcart is placed in a crowded area, accidents can occur when the handcart starts to move on its own. Accordingly, if it is determined from image data that the handcart is placed in a crowded area, the wheel is locked or rotation of the wheel is restrained. This prevents the handcart from suddenly moving, thus preventing potential accidents.

The handcart according to the present disclosure can be configured such that the wheel controller locks the wheel or restrains rotation of the wheel if the cart body state detector detects that the amount of change between images of the surroundings captured by the imaging unit at different times is equal to or greater than a predetermined value.

According to this configuration, image data is used to determine situations such as when the handcart is moving and when there is an object approaching the handcart, and the wheel is locked or rotation of the wheel is restrained accordingly. This prevents accidents that can occur when the handcart suddenly moves.

The handcart according to the present disclosure can be configured such that the cart body state detector detects vibration of the cart body, and the wheel controller locks the wheel or restrains rotation of the wheel if the magnitude of vibration detected by the cart body state detector exceeds a predetermined value.

According to this configuration, the wheel is locked or rotation of the wheel is restrained when large vibration has occurred in the handcart. This prevents the handcart from suddenly moving as a result of the vibration.

The handcart according to the present disclosure can be configured such that the handcart further includes a loading platform, the cart body state detector includes a belt attachment detector/sensor that detects whether a belt used to secure luggage placed on the loading platform is attached, and the wheel controller locks the wheel or restrains rotation of the wheel if the belt attachment detector detects that the belt is not attached.

This configuration minimizes falling of luggage from the loading platform that occurs as a result of the belt not being attached to the luggage.

The handcart according to the present disclosure can be configured such that the handcart further includes a loading platform, the cart body state detector includes a belt expansion/contraction detector/sensor that detects expansion/contraction of a belt used to secure luggage placed on the loading platform, and the wheel controller locks the wheel or restrains rotation of the wheel if the extent of expansion/contraction of the belt detected by the belt expansion/contraction detector exceeds a predetermined value.

According to this configuration, the wheel is locked when the belt that secures the luggage has loosened. This prevents the luggage from falling while the handcart moves.

The handcart according to the present disclosure can be configured to include a warning unit that warns that the wheel has been locked or rotation of the wheel has been restrained by the wheel controller.

According to this configuration, warning is provided to prevent the handcart from falling over when the user tries to move the handcart with the wheel locked or with rotation of the wheel restrained.

According to the prevent disclosure, rather than locking the wheel or restraining rotation of the wheel based solely on the condition that the user is not gripping the grip unit, the wheel is locked or rotation of the wheel is restrained also by taking the state of the cart body into consideration. This makes it possible to achieve a handcart that can be used safely without necessarily compromising usability.

### BRIEF DESCRIPTION OF THE SEVERAL VIEWS OF THE DRAWINGS

FIG. 1 is an exterior perspective view of a handcart according to Embodiment 1.

FIG. 2 is a rear view of the handcart illustrated in FIG. 1.

FIG. 3 is a side view of the handcart illustrated in FIG. 1.

FIG. 4 is an enlarged view of a grip unit of the handcart.

FIG. 5 is an enlarged view of a main wheel of the handcar.

FIG. 6 is a block diagram illustrating the hardware configuration of the handcart according to Embodiment 1.

FIG. 7 illustrates wheel decelerating conditions.

FIG. 8 illustrates wheel locking conditions.

FIGS. 9A-9C explain how the handcart is turned.

FIG. 10 is a flowchart of a process executed by a controller.

FIG. 11 is an exterior perspective view of a handcart according to Embodiment 2.

FIG. 12 is a block diagram illustrating the hardware configuration of the handcart according to Embodiment 2.

FIG. 13 is an exterior perspective view of a handcart according to Embodiment 3.

FIG. 14 is a block diagram illustrating the hardware configuration of the handcart according to Embodiment 3.

### DETAILED DESCRIPTION

### Embodiment 1

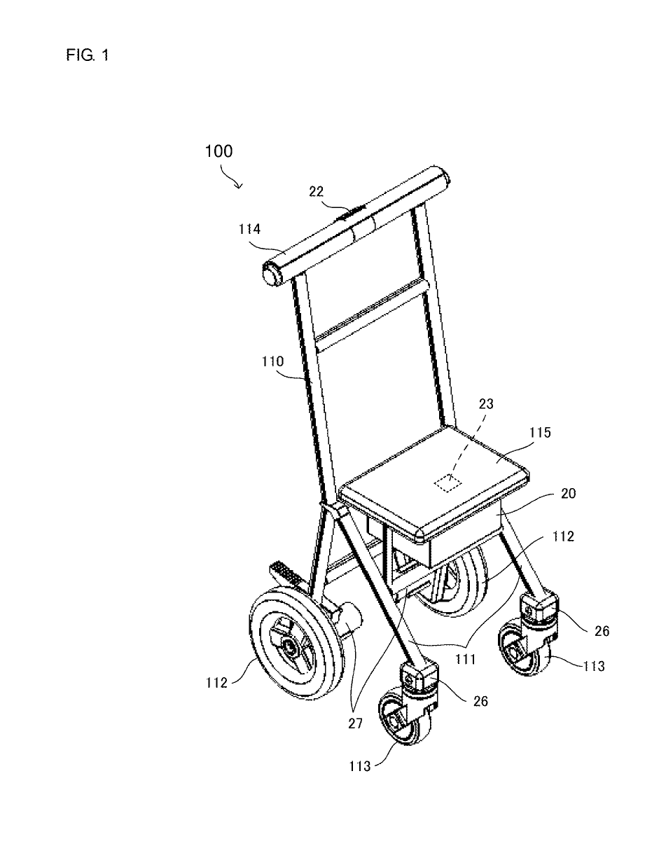

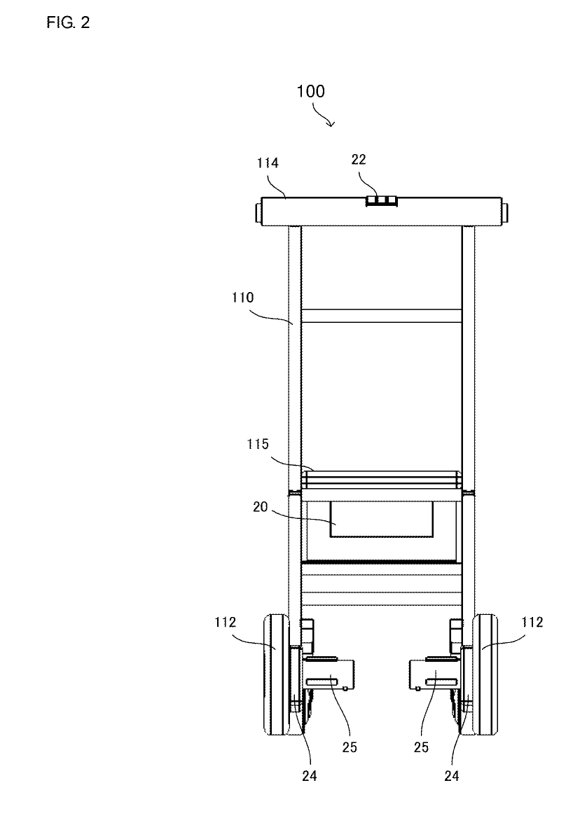

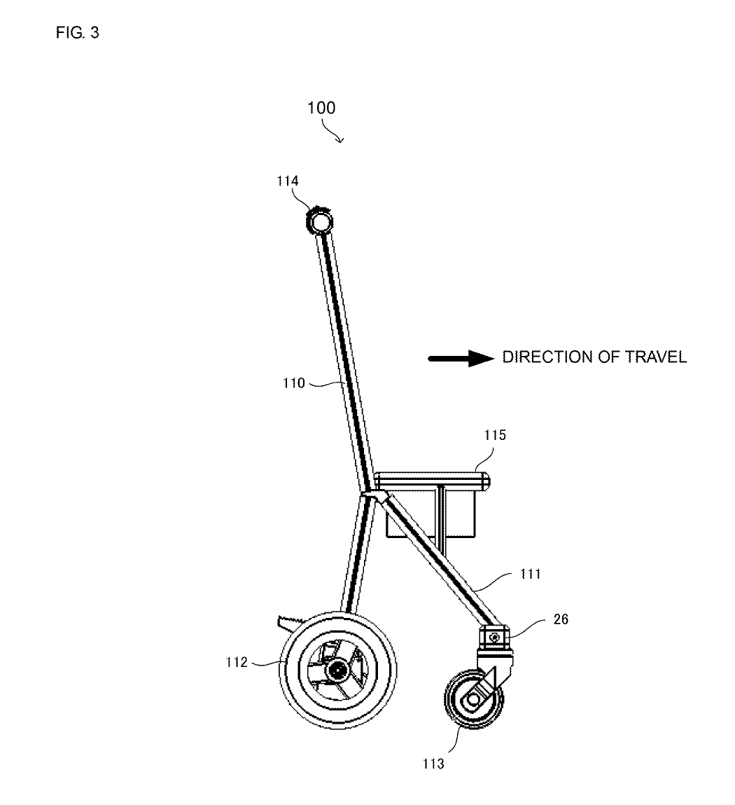

FIG. 1 is an exterior perspective view of a handcart 100 according to Embodiment 1. FIG. 2 is a rear view of the handcart 100 illustrated in FIG. 1. FIG. 3 is a side view of the handcart 100 illustrated in FIG. 1.

The handcart 100 according to Embodiment 1 is a walker that assists users such as elderly and handicapped people in walking. The handcart 100 is also used as a baby carriage or a shopping cart.

The handcart 100 includes a main body unit 110. The main body unit 110 is a frame-like member that extends substantially vertically. The handcart 100 includes a pair of main wheels 112 rotatably supported on the lower end portion of the main body unit 110. The substantially central portion of the main body unit 110 is provided with an auxiliary support 111 that protrudes in the direction in which the handcart 100 travels, with a pair of auxiliary wheels 113 rotatably supported on each end portion of the auxiliary support 111. Thus, for the handcart 100, the pair of main wheels 112 serves as rear wheels, and the pair of auxiliary wheels 113 serve as front wheels. The main wheels 112 have a diameter greater than the diameter of the auxiliary wheels 113.

An upper portion of the main body unit 110 is slightly inclined in a direction opposite to the direction in which the handcart 100 travels. The upper end portion of the main body unit 110 is provided with a grip unit 114 having a cylindrical shape. The grip unit 114 corresponds to “grip unit” according to the present disclosure.

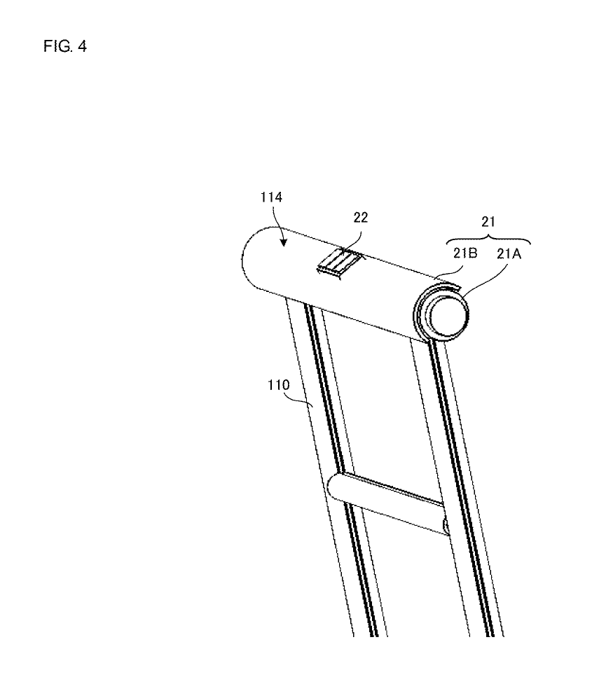

FIG. 4 is an enlarged view of the grip unit 114 of the handcart 100.

The grip unit 114 includes a grip switch 21. The grip switch 21 corresponds to “gripping detector” according to the present disclosure. The grip switch 21 includes a cylindrical member 21A, and a cover 21B having a semi-cylindrical shape disposed along the outer peripheral surface of the cylindrical member 21A.

A gap is present between the cover 21B and the cylindrical member 21A. When the user grips the cover 21B, the cover 21B comes into contact with the cylindrical member 21A. The cylindrical member 21A is provided with a switch (not illustrated). When the user grips the cover 21B, and the cover 21B comes into contact with the cylindrical member 21A, the switch is turned ON. For example, electrodes are provided in the portions of the cylindrical member 21A and the cover 21B that come into contact with each other. Contact between those electrodes causes the switch to turn ON. When the user takes the hands off the cover 21B, and the cover 21B and the cylindrical member 21A are separated from each other, the switch turns OFF. In this way, the grip switch 21 detects whether the user has gripped the grip unit 114.

The structure of the grip switch 21 is not particularly limited. For example, a touch sensor may be provided in a part of the grip unit 114, and user's gripping of the grip unit 114 may be detected by the touch sensor.

A release switch 22 is provided in the grip unit 114 to release wheel lock. As will be described later, the rotation of the pair of main wheels 112 is locked under predetermined conditions. The release switch 22 is used to release the lock on the rotation of the main wheels 112.

A support plate 115 is provided in the substantially central portion of the main body unit 110. For example, the support plate 115 is used by the user to sit on when the handcart is at rest. Alternatively, the support plate 115 is used by the user to put luggage on. The support plate 115 may be provided with a basket for accommodating luggage. A tilt angle sensor 23 is attached to the support plate 115. The tilt angle sensor 23 detects the angle of tilt of the support plate 115 with respect to the vertical direction. A control box 20 is disposed below the support plate 115. The control box 20 contains a battery for supplying a driving voltage to various units of the handcart 100, a control board, and other components. The control box 20 will be described later. The tilt angle sensor 23 corresponds to “cart body state detector” according to the present disclosure.

The support plate 115 may be provided with a placement sensor (not illustrated) that detects placement of luggage or other objects on the support plate 115. Examples of the placement sensor include a load sensor and an infrared sensor.

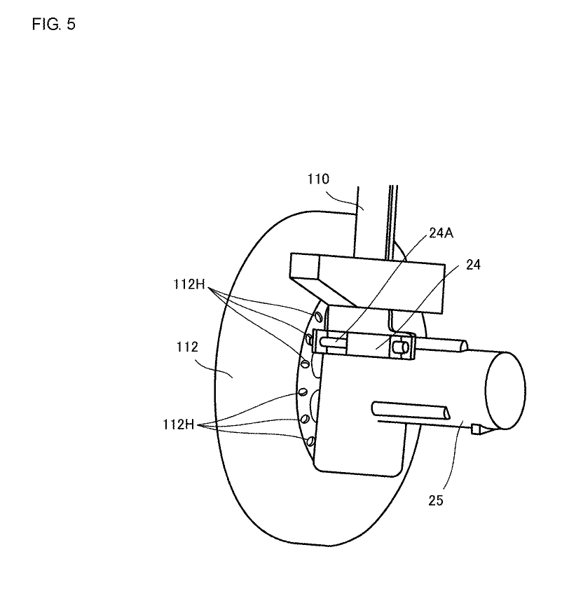

FIG. 5 is an enlarged view of the main wheel 112 of the handcart 100. FIG. 5 is an enlarged view of only one of the pair of main wheels 112. The main wheels 112 are each provided with a wheel lock mechanism 24 and an electric speed reduction mechanism 25. The wheel lock mechanism 24 and the electric speed reduction mechanism 25 correspond to “wheel controller” according to the present disclosure.

The wheel lock mechanism 24 prevents the main wheels 112 from rotating. The wheel lock mechanism 24 is, for example, a linear solenoid that is switched ON or OFF to cause a rod 24A to expand or contact. The main wheels 112 are provided with a plurality of holes 112H. When the wheel lock mechanism 24 is ON, the rod 24A expands, causing the rod 24A to be inserted into the hole 112H and maintained in that state. The main wheels 112 are thus locked. When the wheel lock mechanism 24 is OFF, the rod 24A contracts, causing the rod 24A to move out of the hole 112H. This releases locking of the main wheels 112. Alternatively, the structure of the wheel lock mechanism 24 may be such that a brake shoe is pressed by an electromagnet against a drum attached to the rotatable shaft of the main wheels 112.

When the handcart 100 is moving, the electric speed reduction mechanism 25 gradually restrains the rotation of the main wheels 112, causing the handcart 100 to decelerate. For example, the electric speed reduction mechanism 25 gradually presses a pad or other component onto the rotatable shaft that rotates together with the main wheels 112. This causes the rotational speed of the main wheels 112 to decrease, thus decelerating the handcart 100.

If the handcart 100 is configured such that the main wheels 112 are driven by an electric motor, the rotatable shaft of the main wheels 112 may be rotated in reverse by the motor to decelerate the rotation of the main wheels 112.

A cart body movement detector 26 is provided in a portion of the auxiliary support 111 near each of the auxiliary wheels 113. The cart body movement detector 26 corresponds to “cart body state detector” according to the present disclosure. The cart body movement detector 26 has a camera, and captures an image of the surroundings of the handcart 100. The cart body movement detector 26 has an acceleration sensor, and detects the acceleration at which the handcart 100 moves. Further, the cart body movement detector 26 has a range sensor. When there is an object located forward of the handcart 100, the cart body movement detector 26 detects the distance to the object.

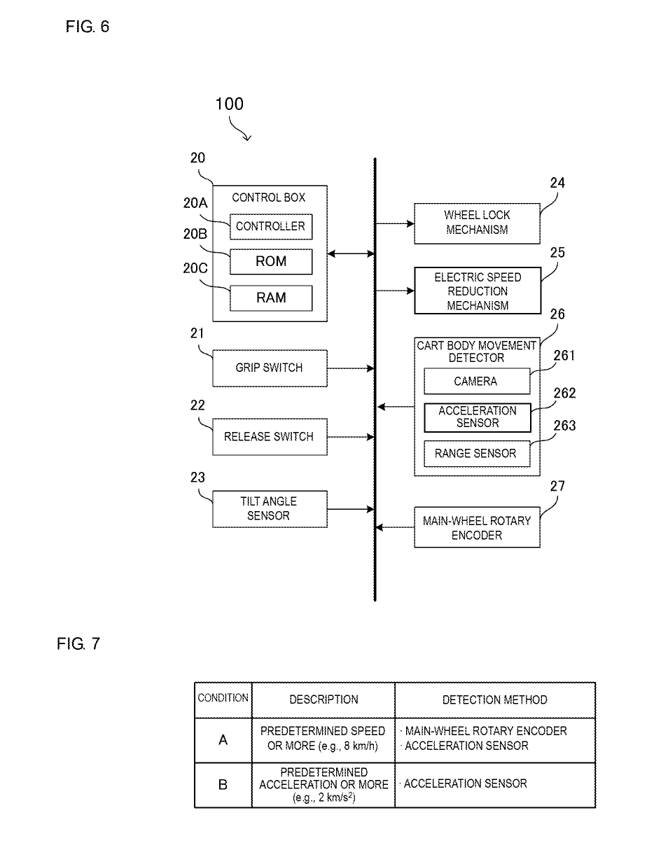

FIG. 6 is a block diagram illustrating the hardware configuration of the handcart 100 according to Embodiment 1.

The handcart 100 includes the control box 20, the grip switch 21, the release switch 22, the tilt angle sensor 23, the wheel lock mechanism 24, the electric speed reduction mechanism 25, the cart body movement detector 26, and a main-wheel rotary encoder 27.

The control box 20 has a controller 20A, a ROM 20B, and a RAM 20C. The controller 20A is a functional unit that controls the handcart 100 in a centralized manner. The controller 20A reads a program stored in the ROM 20B, and loads the program into the RAM 20C to implement various operations.

The grip switch 21 detects user's gripping of the grip unit 114, and outputs a grip detection signal obtained as a result of this detection to the controller 20A.

When the release switch 22 receives a switch operation made by the user, the release switch 22 outputs information to that effect to the controller 20A.

The tilt angle sensor 23 detects the angle of tilt of the support plate 115 with respect to the vertical direction, and outputs the detected tilt angle to the controller 20A.

When the wheel lock mechanism 24 receives, from the controller 20A, a control signal indicating that the wheels be locked, the wheel lock mechanism 24 locks the main wheels 112. When the wheel lock mechanism 24 receives, from the controller 20A, a control signal indicating that the lock be released, the wheel lock mechanism 24 releases the lock on the main wheels 112.

When the electric speed reduction mechanism 25 receives, from the controller 20A, a control signal indicating that the handcart be decelerated, the electric speed reduction mechanism 25 decelerates the rotation of the main wheels 112.

The cart body movement detector 26 includes a camera 261, an acceleration sensor 262, and a range sensor 263. The camera 261 captures an image of the surroundings of the handcart 100, and outputs the resulting image data to the controller 20A. The acceleration sensor 262 detects the acceleration of the handcart 100, and outputs the detected acceleration to the controller 20A. The range sensor 263 detects the distance to an object located forward of the handcart 100, and outputs the detected distance to the controller 20A.

The camera 261, the acceleration sensor 262, and the range sensor 263 correspond to “cart body state detector” according to the present disclosure. The camera 261 also corresponds to “imaging unit” according to the present disclosure.

The main-wheel rotary encoder 27 detects the rotation angle of each of the main wheels 112, and outputs the detected rotation angle to the controller 20A. The controller 20A applies differentiation to the rotation angle of the main wheel 112 input from the main-wheel rotary encoder 27 to calculate the angular speed of the main wheel 112, and further calculates the speed of the main wheel 112. The main-wheel rotary encoder 27 corresponds to “cart body state detector” according to the present disclosure.

When the grip unit 114 of the handcart 100 configured as described above is not being gripped by the user, and the body of the handcart 100 is in a predetermined state, the main wheels 112 are locked to disable movement of the handcart 100. Although described later in detail, this predetermined state is, for example, when the handcart 100 is moving at a speed equal to or greater than a predetermined value. Accordingly, if the user forgets to lock the main wheels 112 and leaves the handcart 100 in that state in an inclined area such as a slope, the above-mentioned configuration prevents accidents that can occur when the handcart 100 starts to move on its own in this case.

If the main wheels 112 are locked suddenly while the handcart 100 is moving, for example, this can cause the luggage placed on the handcart 100 to be thrown out, or can cause the handcart 100 to fall over. Accordingly, when the handcart 100 is moving at a certain speed or more, the handcart 100 is decelerated before the main wheels 112 are locked. This allows the handcart 100 to come to a safe stop.

Wheel decelerating conditions and wheel locking conditions will be described below in detail.

FIG. 7 illustrates wheel decelerating conditions.

When the grip unit 114 is not being gripped by the user, and either one of Condition A and Condition B described below is satisfied, the controller 20A outputs a control signal to the electric speed reduction mechanism 25. Then, the electric speed reduction mechanism 25 causes the rotation of the main wheels 112 to decelerate.

(Condition A)

Condition A represents when the handcart 100 is moving at a speed equal to or greater than a predetermined value (for example, 8 km/h). The controller 20A calculates the speed of each of the main wheels 112 from the rotation angle of the main wheel 112 input from the main-wheel rotary encoder 27, or calculates the speed of each of the main wheels 112 from an acceleration input from the acceleration sensor 262. The controller 20A determines whether Condition A is satisfied from the calculated speed.

(Condition B)

Condition B represents when the handcart 100 is moving at an acceleration equal to or greater than a predetermined value (for example, 2 km/s²). The controller 20A determines whether Condition B is satisfied from an acceleration input from the acceleration sensor 262.

If Condition A or B is satisfied, this indicates that the handcart 100 is moving at a speed or an acceleration equal to or greater than a predetermined value. Thus, under these conditions, the controller 20A gives higher priority to decelerating the rotation of the main wheels 112 than to locking the wheels. This allows the handcart 100 to come to a safe stop.

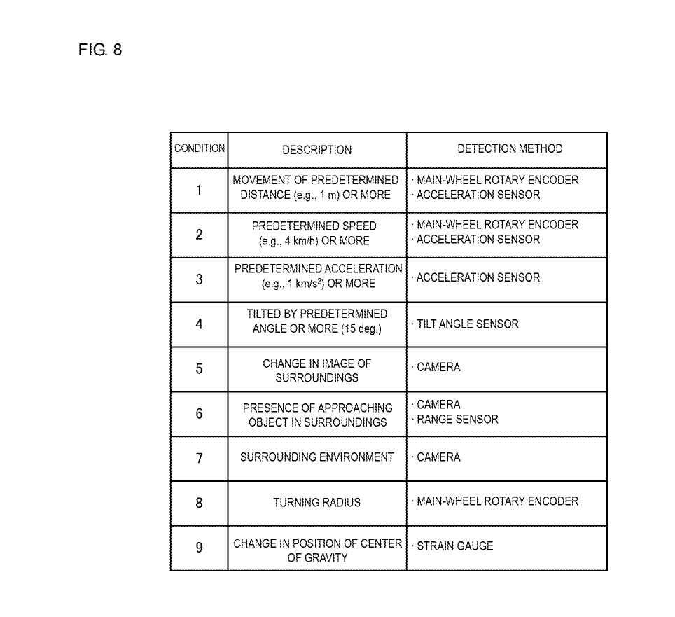

FIG. 8 illustrates wheel locking conditions.

When the grip unit 114 is not being gripped by the user, and any one of Conditions 1 to 9 described below is satisfied, the controller 20A outputs a control signal to the wheel lock mechanism 24. Then, the wheel lock mechanism 24 locks the main wheels 112.

Conditions 1 to 3 represent when the handcart 100 is moving while satisfying a predetermined condition.

(Condition 1)

Condition 1 represents when the handcart 100 has moved a predetermined distance (for example, 1 m). The controller 20A calculates the distance moved from the rotation angle of each of the main wheels 112 input from the main-wheel rotary encoder 27. Alternatively, the controller 20A calculates the speed of each of the main wheels from an acceleration input from the acceleration sensor 262, and calculates the distance moved from the calculated speed and the measurement time. The controller 20A determines whether Condition 1 is satisfied from the calculated distance moved.

In some situations, a user wanting to change the direction of the handcart 100 turns the handcart 100 on the spot. In this case, the main wheels 112 sometimes rotate. Locking the main wheels 112 or restraining the rotation of the main wheels 112 in this case leads to decreased usability for the user. This problem is addressed as follows. That is, when determining whether Condition 1 is met, the controller 20A calculates the respective rotation speeds of the main wheels 112. Based on the calculated rotation speeds, the controller 20A does not determine Condition 1 to be met if the handcart 100 is turning on the spot, even if the handcart 100 is determined to have moved a certain distance or more.

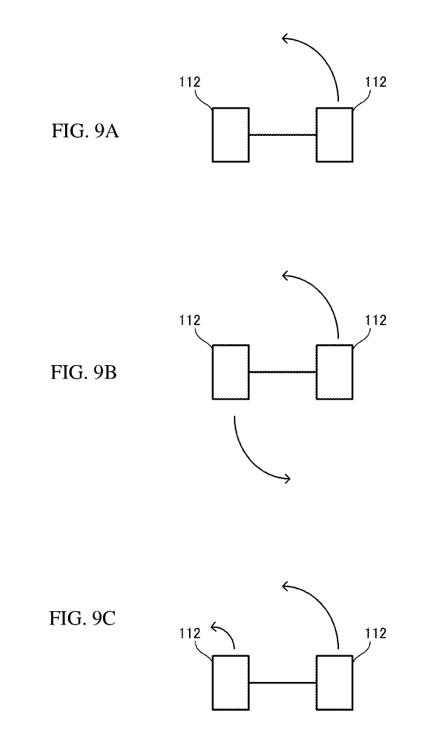

FIGS. 9A-9C explain how the handcart 100 is turned. For example, situations where the handcart 100 is turned on the spot include when one of the pair of main wheels 112 does not rotate and only the other rotates as illustrated in FIG. 9A, and when each of the pair of main wheels 112 rotates in an opposite direction as illustrated in FIG. 9B. When each of the pair of main wheels 112 rotates in the same direction as illustrated in FIG. 9C, the handcart 100 is not turning on the spot but is moving while turning in the direction of its travel.

The controller 20A determines whether the handcart 100 is turning on the spot based on whether the difference between the respective rotation speeds of the main wheels 112 exceeds a threshold. Specifically, this determination is made as follows. Assuming that the threshold is “10”, if the rotation speed of one of the main wheels 112 illustrated in FIG. 9A is “0”, and the rotation speed of the other main wheel 112 is “15”, the difference in rotation speed is obtained as follows: 15−0=15. The difference, 15, is greater than the threshold of 10. Consequently, in the case of FIG. 9A, the controller 20A determines that the handcart 100 is turning on the spot, and thus does not determine Condition 1 to be met. In the case of FIG. 9B, if the rotation speed of one of the main wheels 112 is “−15”, and the rotation speed of the other main wheel 112 is “15”, the difference in rotation speed is obtained as follows: 15−(−15)=30. The difference, 30, is greater than the threshold of 10. Consequently, in the case of FIG. 9B, the controller 20A determines that the handcart 100 is turning on the spot, and thus does not determine Condition 1 to be met. In the case of FIG. 9C, if the rotation speed of one of the main wheels 112 is “10”, and the rotation speed of the other main wheel 112 is “15”, the difference in rotation speed is obtained as follows: 15−10=5. The difference, 5, is less than the threshold of 10. Consequently, in the case of FIG. 9C, the controller 20A determines that the handcart 100 is moving while turning in the direction of its travel, and thus determines Condition 1 to be met.

The determination of whether the handcart 100 is turning on the spot may be also made based on the distances moved by the respective main wheels 112.

As described above, when the user turns the handcart 100 on the spot, the controller 20A excludes this situation from Condition 1. This prevents the main wheels 112 from being locked or prevents rotation of the main wheels 112 from being restrained when the user wants to change the direction of the handcart 100, thus avoiding a decrease in usability for the user.

(Condition 2)

Condition 2 represents when the handcart 100 is moving at a speed equal to or greater than a predetermined value (for example, 4 km/h). The controller 20A calculates the speed of each of the main wheels 112 from the rotation angle of the main wheel 112 input from the main-wheel rotary encoder 27, or calculates the speed of each of the main wheels 112 from an acceleration input from the acceleration sensor 262. The controller 20A determines whether Condition 2 is satisfied from the calculated speed.

(Condition 3)

Condition 3 represents when the handcart 100 is moving at an acceleration equal to or greater than a predetermined value (for example, 1 km/s²). The controller 20A determines whether Condition 3 is satisfied from an acceleration input from the acceleration sensor 262.

Conditions 1 to 3 indicate that the handcart 100 is moving. If only the slightest movement of the handcart 100 causes the main wheels 112 to be locked, the user needs to take the trouble of releasing the lock on the wheels. Accordingly, the distance moved, or the speed or acceleration of movement is detected, and the main wheels 112 are locked when it is determined that the handcart 100 has definitely moved a certain amount or more. This saves trouble for the user without necessarily compromising usability. Locking the main wheels 112 prevents accidents from occurring due to movement of the handcart 100.

If Condition A or B illustrated in FIG. 7 is also satisfied when Condition 2 or 3 is satisfied, the controller 20A gives priority to activating the electric speed reduction mechanism 25.

Conditions 4 to 7 are conditions determined by the state in the surroundings of the handcart 100.

(Condition 4)

Condition 4 represents when the handcart 100 is tilted by an angle equal to or greater than a predetermined value (for example, 15 degrees). The controller 20A determines whether Condition 4 is satisfied based on the angle of tilt of the support plate 115 with respect to the vertical direction, which is input from the tilt angle sensor 23. Checking Condition 4 makes it possible to detect that the handcart 100 is placed on a slope. Locking the main wheels 112 in this state prevents accidents that can occur when the handcart starts to move on its own.

(Condition 5)

Condition 5 represents when there is a change between captured images of the surroundings of the handcart 100. The controller 20A compares pieces of image data input at different times from the camera 261, and determines whether Condition 5 is satisfied based on whether there is any change between these pieces of image data. For example, the camera 261 captures images of the area forward of the handcart 100 at different times. The controller 20A determines that there is no change between the captured images of the surroundings if these pieces of image data match, and determines that there is a change between the captured images of the surroundings if these pieces of image data do not match. If there is a change between the captured images of the surroundings, this indicates, for example, that the handcart 100 is moving in the direction of travel or in a direction opposite to the direction of travel.

At this time, the controller 20A determines that pieces of image data to be compared match, not only when the pieces of image data to be compared completely match but also when there is a slight error between these pieces of data. Further, the camera 261 may capture images of not the area forward of the handcart 100 but the area to the side of the handcart 100.

Alternatively, for example, the controller 20A calculates differences between images taken at certain time intervals to determine movement of an object in the surroundings, such as a bicycle, or the distance to the wall of a building, a step on a road, or a piece of luggage that is placed. Then, the controller 20A determines whether the current state is potentially dangerous, thus determining whether Condition 5 is satisfied.

(Condition 6)

Condition 6 represents when there is an object approaching the handcart 100. The controller 20A compares pieces of image data input at different times from the camera 261, and determines whether Condition 6 is satisfied based on whether there is any change between these pieces of image data. Further, the controller 20A determines whether Condition 6 is satisfied based on whether the distance to an object located forward of the handcart 100, which is detected by the range sensor 263, is decreasing with the elapse of time.

(Condition 7)

Condition 7 represents the surrounding environment of the handcart 100, for example, when there are many objects in the surroundings of the handcart 100. For example, the camera 261 captures an image of the area forward of or around the handcart 100, and outputs the resulting image data to the controller 20A. The controller 20A determines, from the image data, whether there is any object located forward of or around the handcart 100 to thereby determine whether Condition 7 is satisfied. Checking Condition 7 makes it possible to detect that, for example, the handcart 100 is placed in a crowded area, thus preventing accidents that can occur when the handcart 100 starts to move on its own.

(Condition 8)

Condition 8 represents when the turning radius of the handcart 100 is equal to or greater than a predetermined value (for example, half the length between the pair of main wheels 112). For example, the controller 20A calculates, from the respective rotation angles of the pair of main wheels 112 input from the main-wheel rotary encoder 27, the distances moved by the individual main wheels 112, and calculates a turning radius from the difference between the calculated distances moved. The controller 20A determines whether the calculated turning radius is less than a predetermined value to thereby determine whether Condition 8 is satisfied. A smaller turning radius tends to cause the handcart 100 to lose its balance. Thus, checking Condition 8 makes it possible to prevent, for example, accidents from occurring when the handcart 100 loses its balance and moves in a manner unintended by the user.

(Condition 9)

Condition 9 represents when the position of the overall center of gravity of the cart body is determined to have changed based on the weight of the handcart 100. The position of the overall center of gravity of the cart body is assumed to be the position of the center of gravity for the sum of the self-weight of the handcart 100 and the weight acting on the support plate 115. For example, the position of the center of gravity is calculated by using a plurality of sensors each formed by a strain gauge whose electrical resistance varies with applied pressure. The electrical resistances of individual stain gauges are determined to detect pressures applied to the individual sensors to thereby calculate the position of the center of gravity. The controller 20A determines whether the position of the center of gravity has changed by a predetermined value or more to thereby determine whether Condition 9 is satisfied. Checking Condition 9 makes it possible to prevent accidents from occurring when the handcart 100 loses its balance and moves in an unintended manner.

Conditions 4 to 9 represent conditions in which, although the handcart 100 is at rest, there is a risk that the handcart 100 can move or that, if the handcart 100 moves, the handcart 100 will come into contact with another object, leading to accidents. Accordingly, the controller 20A locks the wheels if one of Conditions 4 to 9 is satisfied. This prevents accidents that can occur when the handcart 100 starts to move on its own.

The thresholds used in determining whether Conditions 1 to 9 are met can be changed as appropriate. For example, when no luggage is loaded on the support plate 115, higher priority is often given to the operability of the handcart 100 than to ensuring safety compared with when there is luggage loaded on the support plate 115. Accordingly, the threshold may be made to differ between when luggage or another such object is loaded on the support plate 115 and when there is no loaded luggage or object. More specifically, the greater the weight of the luggage, the greater the load required to lock the wheels once the handcart 100 has started to move. Accordingly, the threshold is decreased as the weight of the luggage increases, thus increasing the probability of one of Conditions 1 to 9 being satisfied. This increases the possibility of the main wheels 112 being locked. As a result, the handcart 100 can be used more safely.

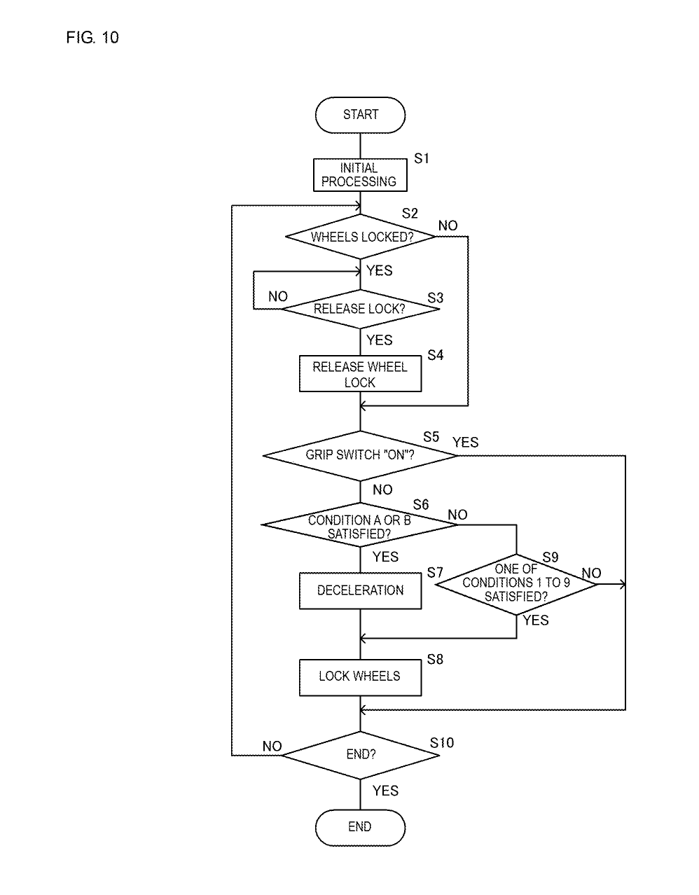

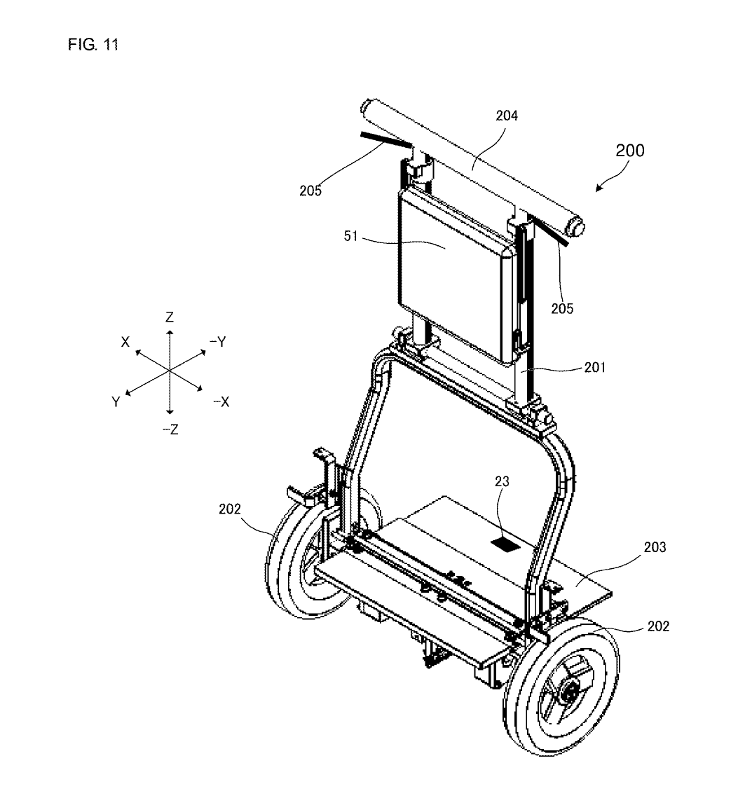

FIG. 10 is a flowchart of a process executed by the controller 20A.

The controller 20A executes the process illustrated in FIG. 10 when, for example, the power switch of the handcart 100 is turned ON. The controller 20A performs initial processing necessary for driving various units or parts of the handcart 100 (S1). Next, the controller 20A detects, for example, whether the wheel lock mechanism 24 is active, and determines whether the main wheels 112 are locked (S2).

If the main wheels 112 are not locked (S2: NO), the controller 20A executes step S5. If the main wheels 112 are locked (S2: YES), the controller 20A determines whether the release switch 22 has been switched ON to release the lock on the main wheels 112 (S3). If the release switch 22 has not been switched ON to release the lock (S3: NO), the controller 20A waits until the release switch 22 is switched ON. If the release switch 22 has been switched ON to release the lock (S3: YES), the controller 20A activates the wheel lock mechanism 24, and releases the lock on the main wheels 112 (S4).

The lock on the main wheels 112 may be released by a mechanical structure. In this case, steps S2 to S4 are not required.

Next, the controller 20A determines whether the grip switch 21, which detects whether the user is gripping the grip unit 114, has been switched ON (S5). If the grip switch 21 has not been switched ON (S5: NO), that is, if the grip unit 114 is not being gripped by the user, the controller 20A determines whether Condition A or Condition B described above with reference to FIG. 7 is satisfied (S6).

If Condition A or Condition B is satisfied (S6: YES), this indicates that the handcart 100 is moving at a certain speed or more. Thus, the controller 20A activates the electric speed reduction mechanism 25 to decelerate the handcart 100 that is moving (S7). Then, the controller 20A activates the wheel lock mechanism 24 to lock the main wheels 112 (S8), thus preventing the handcart 100 form moving.

When the handcart 100 is moving at a predetermined speed or acceleration, suddenly locking the main wheels 112 can cause the luggage placed on the handcart 100 to be thrown out, or can cause the handcart 100 to fall over, for example. Accordingly, when the handcart 100 is moving at a certain speed or acceleration or more, the handcart 100 is decelerated to allow the handcart 100 to come to a safe stop.

If Condition A or Condition B is not satisfied (S6: NO), the controller 20A determines whether one of Conditions 1 to 9 described above with reference to FIG. 8 is satisfied (S9). If one of Conditions 1 to 9 is satisfied (S9: YES), the controller 20A activates the wheel lock mechanism 24 to lock the main wheels 112 (S8), thus preventing the handcart 100 form moving. If one of Conditions 1 to 9 is not satisfied (S9: NO), the controller 20A executes step S10.

At step S10, the controller 20A determines, for example, whether the power switch of the handcart 100 has been turned OFF to end the current process (S10). If the current process is to be ended (S10: YES), the controller 20A ends the current process. If the current process is not to be ended (S10: NO), the controller 20A executes step S2.

The controller 20A may either decelerate the rotation of the main wheels 112 if one of Conditions A and B is satisfied, or decelerate the rotation of the main wheels 112 if both of Conditions A and B is satisfied. Further, the controller 20A may either lock the main wheels 112 if one of Conditions 1 to 7 is satisfied, or lock the main wheels 112 if any two or more of Conditions 1 to 7 is satisfied.

As described above, when the grip unit 114 of the handcart 100 is not being gripped by the user, and the body of the handcart 100 is in a predetermined state, the main wheels 112 are locked. As a result, when an external object comes into contact with the handcart 100, and the handcart 100 thus starts to move on its own while the user who has forgotten to lock the main wheels 112 leaves the handcart 100 in that state, the main wheels 112 are locked to prevent potential accidents. Further, if the user who has forgotten to lock the main wheels 112 leaves the handcart 100 in that state in an inclined area such as a slope, the above-mentioned configuration prevents accidents that can occur when the handcart 100 starts to move on its own. Further, when the handcart 100 is moving, the handcart 100 is decelerated before the main wheels 112 are locked. This allows the handcart 100 to come to a safe stop.

In Embodiment 1 described above, the main wheels 112 of the handcart 100 are locked if any one of Conditions A, B, and 1 to 9 is satisfied. Alternatively, for example, under Conditions A, B, and 1 to 3 when the handcart 100 is moving, the main wheels 112 may not be locked, and only the rotation of the main wheels 112 may be restrained. In this case, the handcart 100 can be decelerated while moving, thus allowing the user to easily catch the handcart 100.

Although the handcart 100 has been described above to include components such as the camera 261, the acceleration sensor 262, and the range sensor 263, the handcart 100 may not include all of these components. For example, in one embodiment, the handcart 100 does not include the acceleration sensor 262, and the speed of movement is detected by the main-wheel rotary encoder 27 to determine that the handcart 100 is moving at a certain speed or more. In another embodiment, the handcart 100 includes, other than the camera 261 or such devices, a unit that can detect movement of the handcart 100 and a unit that can detect the surrounding environment of the handcart 100, and the control to lock the main wheels 112 or the control to decelerate the rotation of the main wheels 112 is performed by using these units.

When the main wheels 112 are to be locked, the lock may be applied after the main wheels 112 are rotated in reverse. In this case, in situations where not even the slightest forward movement is tolerated after sudden braking is applied, such as when there is a cliff or depression in the direction of travel of the handcart 100 on a downhill, the main wheels 112 are rotated in reverse, thus allowing the main wheels 112 to be effectively locked. Although there are various ways of locking the main wheels 112, such as instantaneously locking (suddenly braking) the main wheels 112, locking the main wheels 112 while gradually restraining their rotation, and locking the main wheels 112 after rotating the main wheels 112 in reverse, the specific method of locking the main wheels 112 may be either selected by the user or selected automatically in accordance with the surrounding environment as determined by an imaging unit such as a camera.

Further, the controller 20A may have a watchdog function to monitor whether the system is running properly. More specifically, a program being executed by the controller 20A reports proper running of the system to the watchdog at predetermined time intervals. When an abnormality occurs, and no reporting is made to the watchdog for a predetermined time or more, a process that is determined in advance by the watchdog to be performed in the event of an abnormality, for example, locking of the main wheels 112, is executed. This prevents the handcart 100 from running out of control in the event of an abnormality detected by the controller 20A.

### Embodiment 2

A handcart according to Embodiment 2 is a movable body with a pair of main wheels driven and controlled by an electric motor to perform inverted pendulum control.

FIG. 11 is an exterior perspective view of a handcart 200 according to Embodiment 2.

The handcart 200 includes a main body unit 201, a pair of main wheels 202, a support 203, a restricting part (not illustrated), the tilt angle sensor 23, a Gyro sensor, and a seating plate 51.

The main body unit 201 is a frame-like member that is long in the vertical direction (Z/−Z direction illustrated in FIG. 11) and short in the depth direction (Y/−Y direction illustrated in FIG. 11). The main body unit 201 contains a battery for supplying a driving voltage to various units of the handcart 200, a control board, and other components.

One vertically lower (direction −Z illustrated in FIG. 11) end portion of the main body unit 201 is supported on the rotatable shaft of the pair of main wheels 202 so as to be rotatable in the pitch direction.

The support 203 is a plate-like member that extends in parallel to the horizontal ground with respect to the direction of travel (direction Y illustrated in FIG. 11) of the handcart 200. The support 203 is supported on the pair of main wheels 202 so as to be rotatable in the pitch direction.

The main wheels 202 are attached to the same shaft, and rotate in synchronism with each other. However, it is also possible to individually drive and rotate the two main wheels 202.

The other end portion of the main body unit 201 located opposite to the main wheels 202 is provided with a grip unit 204 having a cylindrical shape. The grip unit 204 is provided with a switch to detect whether the user has gripped the grip unit 204. A manual brake 205 is attached to a position on the main body unit 201 near the grip unit 204.

The user uses the handcart 200 by either gripping the grip unit 204, or by using friction generated between the grip unit 204 and a user's body part such as a forearm placed on the grip unit 204.

The main body unit 201 is provided with the Gyro sensor. The upper surface of the support 203 is provided with the tilt angle sensor 23. The Gyro sensor will be described later in detail.

The restricting part is located at the connection between the main body unit 201 and the support 203. The restricting part, which is a stopper, physically restricts the main body unit 201 and the support 203 from forming an angle less than a predetermined value.

Next, the configuration and basic operation of the handcart 200 will be described.

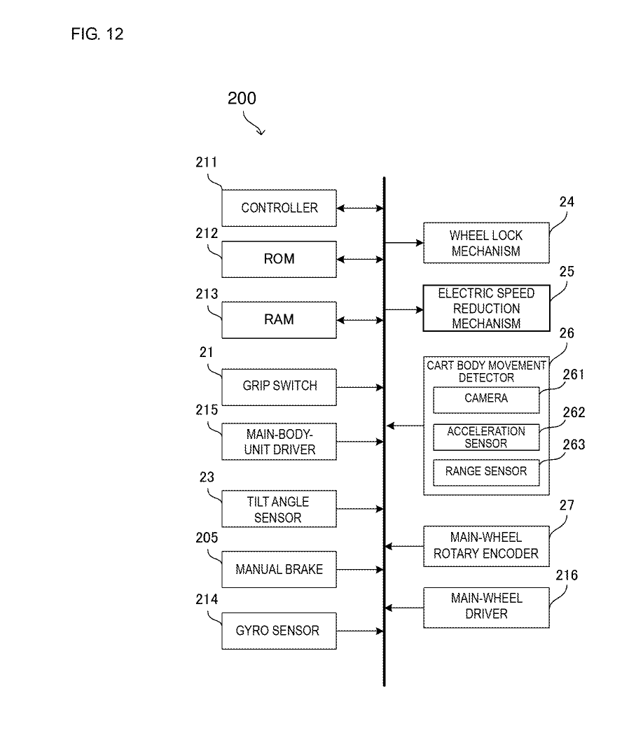

FIG. 12 is a block diagram illustrating the hardware configuration of the handcart 200 according to Embodiment 2. As illustrated in FIG. 12, the handcart 200 includes the tilt angle sensor 23, a controller 211, a ROM 212, a RAM 213, a Gyro sensor 214, a main-body-unit driver 215, a main-wheel driver 216, and the manual brake 205.

The controller 211 is a functional unit that controls the handcart 200 in a centralized manner. The controller 211 reads a program stored in the ROM 212, and loads the program into the RAM 213 to implement various operations.

The main-body-unit driver 215 drives a motor located at the connection between the main body unit 201 and the support 203 to thereby rotate the main body unit 201 in the pitch direction.

The tilt angle sensor 23 detects the angle of tilt of the support 203 with respect to the vertical direction, and outputs the detected tilt angle to the controller 211. Based on the tilt angle detected by the tilt angle sensor 23, the controller 211 estimates the angle at which the ground on which the handcart 200 lies is tilted with respect to the vertical direction.

The Gyro sensor 214 detects the angular speed of the main body unit 201 in the pitch direction, and outputs the detected angular speed to the controller 211.

As its basic operation, the controller 211 detects, based on the detection result from the Gyro sensor 214, the angular variation of the angle of tilt of the main body unit 201 in the pitch direction, and controls the main-wheel driver 216 such that the angular variation of the main body unit 201 becomes zero and that the angle of the main body unit 201 with respect to the vertical direction becomes a target angle (for example, zero or a value close to zero).

The main-wheel driver 216 is a functional unit that drives the motor that rotates the shaft attached to the main wheels 202. The main-wheel driver 216 rotates the main wheels 202 under control of the controller 211. The main-wheel driver 216 is provided in the bottom surface of the support 203 to drive the pair of main wheels 202.

As described above, the handcart 200 performs inverted pendulum control as its basic operation, and controls the position of the main body unit 201 so as to remain substantially constant. This allows the handcart 200 to keep a substantially constant position when the user pushes the handcart 200 while gripping the grip unit 204, thus ensuring good operability of the handcart 200.

With the inverted pendulum control performed constantly, the risk of falling over of the handcart 200 is reduced even when only the main wheels 202 are in contact with the ground.

The handcart 200 includes the wheel lock mechanism 24, the electric speed reduction mechanism 25, the cart body movement detector 26, and the main-wheel rotary encoder 27 identical to those in Embodiment 1. As described above with reference to Embodiment 1, when the grip unit 204 of the handcart 200 is not being gripped by the user, and the body of the handcart 200 is in a predetermined state, the main wheels 202 are locked. As a result, if the user forgets to lock the main wheels 202 and leaves the handcart 200 in that state in an inclined area such as a slope, the above-mentioned configuration prevents accidents that can occur when the handcart 200 starts to move on its own. Further, when the handcart 200 is moving, the handcart 200 is decelerated before the main wheels 202 are locked. This allows the handcart 200 to come to a safe stop.

Although the handcart 200 according to Embodiment 2 includes components such as the camera 261, the acceleration sensor 262, and the range sensor 263 as in Embodiment 1, the handcart 200 may not include all of these components. For example, in one embodiment, the handcart 200 does not include the acceleration sensor 262, and the speed of its movement is detected based on the angular speed obtained by the main-wheel rotary encoder 27 to thereby determine that the handcart 200 is moving at a certain speed or more. In another embodiment, the handcart 200 includes, other than the camera 261 or such devices, a unit that can detect movement of the handcart 200 and a unit that can detect the surrounding environment of the handcart 200, and the control to lock the main wheels 202 or the control to decelerate the rotation of the main wheels 202 is performed by using these units.

Otherwise, the features and modifications described above with reference to Embodiment 1 are applicable to Embodiment 2 as appropriate.

### Embodiment 3

A handcart according to Embodiment 3 is a movable body with a pair of main wheels driven and controlled by an electric motor to perform inverted pendulum control.

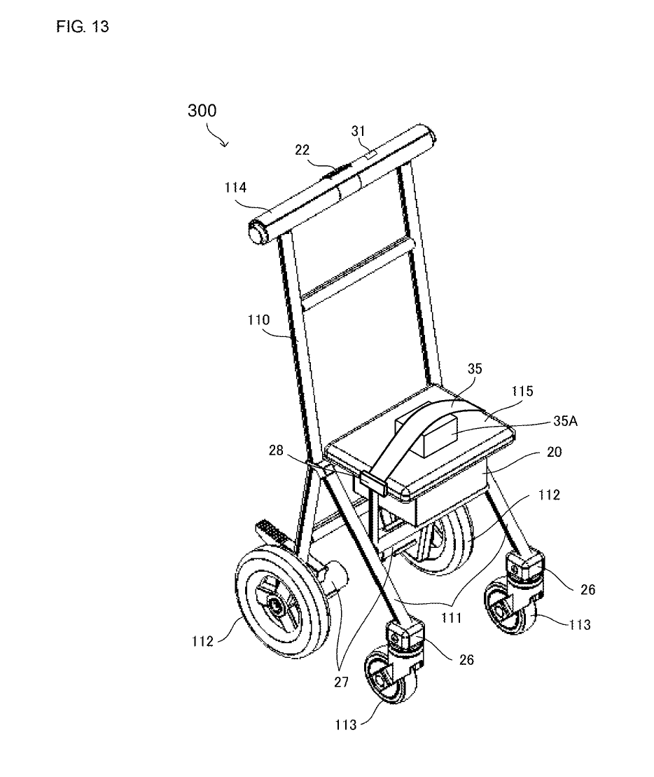

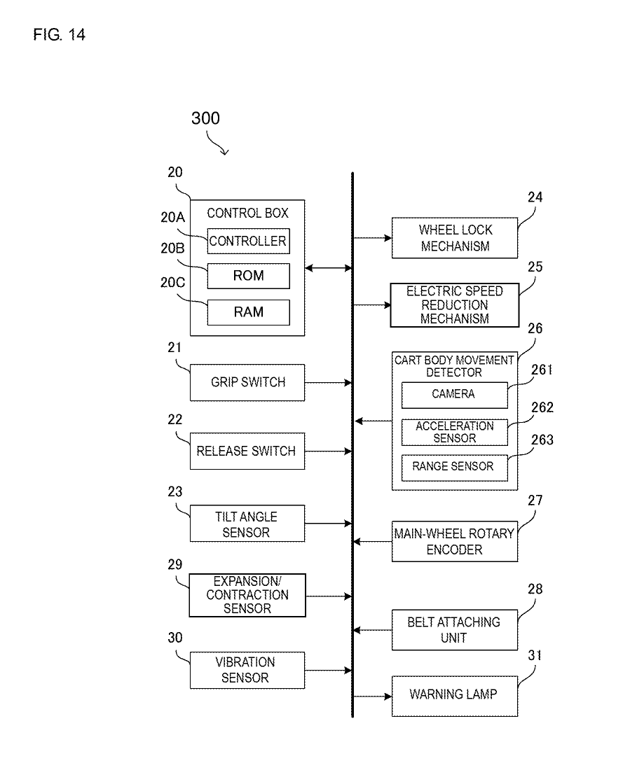

FIG. 13 is an exterior perspective view of a handcart 300 according to Embodiment 3. FIG. 14 is a block diagram illustrating the hardware configuration of the handcart 300 according to Embodiment 3.

The handcart 300 according to Embodiment 3 includes, in addition to the components of the handcart 100 according to Embodiment 1, a belt attaching unit 28, an expansion/contraction sensor 29, a vibration sensor 30, and a warning lamp 31.

The belt attaching unit 28 detachably secures a belt 35 that keeps a piece of luggage 35A placed on the support plate 115 from moving. For example, the belt 35 is directly secured to the support plate 115 at one end, and secured to the belt attaching unit 28 at the other end. The belt attaching unit 28 detects whether the belt 35 is attached, by a switch that is switched ON upon attachment of the belt 35, a proximity sensor, or other devices. The belt attaching unit 28 corresponds to “belt attachment detector” according to the present disclosure. Further, the support plate 115 corresponds to “loading platform” according to the present disclosure.

The belt attaching unit 28 detects whether the belt 35 is attached, and the wheel lock mechanism 24 locks the main wheels 112 depending on the detection result. For example, when the belt 35 that has been attached is removed, the wheel lock mechanism 24 locks the main wheels 112. This minimizes, for example, slipping of the luggage 35A when the user forgets to attach the belt 35 used to secure the luggage 35A. Alternatively, for example, the handcart 300 is provided with a sensor that detects placement of the luggage 35A on the support plate 115, and the wheel lock mechanism 24 locks the main wheels 112 if the belt 35 is not attached when the luggage 35A is being placed on the support plate 115. This minimizes slipping of the luggage 35A that occurs when the user forgets to secure the luggage 35A.

The expansion/contraction sensor 29 detects expansion/contraction of the belt 35. For example, the expansion/contraction sensor 29 detects expansion/contraction of the belt 35 relative to when the belt 35 is securing the luggage 35A. The expansion/contraction sensor 29 may detect expansion/contraction of the belt 35 by a piezoelectric film or strain sensor provided to the belt 35. If, for example, the belt 35 is stored while being wound up on a belt reel, the expansion/contraction sensor 29 may detect rotation of the belt reel to detect expansion/contraction of the belt 35.

If it is determined as a result of detection of expansion/contraction of the belt 35 by the expansion/contraction sensor 29 that the belt 35 has loosened, the wheel lock mechanism 24 locks the main wheels 112. This prevents the luggage 35A from falling.

The timing to lock the main wheels 112 depending on the result of detection of expansion/contraction of the belt 35 by the expansion/contraction sensor 29 is not particularly limited. For example, if it is determined while the handcart 300 is running that the belt 35 has loosened, the main wheels 112 may be locked after being decelerated. Alternatively, the main wheels 112 may be locked if it is determined while the handcart 300 is at rest that the belt 35 has loosened.

The vibration sensor 30 detects vibration of the body of the handcart 300. The vibration sensor 30, which is not illustrated in FIG. 13, is disposed inside the support plate 115, for example. The vibration sensor 30 corresponds to “cart body state detector” according to the present disclosure. Alternatively, vibration of the cart body may be detected by the acceleration sensor 262, a torque sensor, or other sensors.

When the vibration sensor 30 detects a vibration of the cart body that exceeds a predetermined value, the wheel lock mechanism 24 locks the main wheels 112. For example, when the handcart 300 undergoes large vibration while moving, the luggage 35A placed on the support plate 115 may fall from the support plate 115. Accordingly, the main wheels 112 are locked when the handcart 300 is undergoing large vibration, thus preventing falling of the luggage 35A, for example. If the user is carrying the handcart 300 while riding in a vehicle (such as a bus or train), there is a risk of the handcart 300 starting to move on its own. Accordingly, the main wheels 112 are locked upon detecting vibration to thereby prevent the handcart 300 from starting to move on its own.

The warning lamp 31, which is provided in the grip unit 114, flashes or lights up to warn that the main wheels 112 have been locked. Warning the user that the main wheels 112 have been locked makes it possible to prevent the user from falling over when the user tries to move the handcart 300 with the main wheels 112 being locked. The warning lamp 31 corresponds to “warning unit” according to the present disclosure. The warning that the main wheels 112 have been locked may be provided by sound, vibration, or other means.

As described above, the main wheels 112 of the handcart 300 are locked when the cart body is undergoing large vibration, when the belt 35 used to secure the luggage 35A is not attached, or when the belt 35 that has been attached is loosened or detached. This prevents the handcart 300 from starting to move on its own, or prevents falling of the luggage 35A from the support plate 115.

It has been described in Embodiment 3 that the handcart 300 carries the luggage 35A. In this regard, the luggage 35A is not limited to a non-living object but may be a living object. That is, the handcart 300 may be, for example, a baby carriage in which an infant is carried. In this case, the support plate 115 corresponds to a chair, and the luggage 35A corresponds to an infant. If the handcart 300 is a baby carriage, an infant sometimes moves while riding in such a baby carriage. Accordingly, the configuration according to the present disclosure makes it possible to prevent the handcart 300 from starting to move on its own when the infant moves, or prevent the infant from falling off the chair (the support plate 115).

Otherwise, the features and modifications described above with reference to Embodiments 1 and 2 are applicable to Embodiment 3 as appropriate.

### REFERENCE SIGNS LIST

20 control box
20A controller
20B ROM
20C RAM
21 grip switch (gripping detector)
21A cylindrical member
21B cover
22 release switch
23 tilt angle sensor (cart body state detector)
24 wheel lock mechanism (wheel controller)
25 electric speed reduction mechanism (wheel controller)
26 cart body movement detector (cart body state detector)
27 main-wheel rotary encoder (cart body state detector)
28 belt attaching unit (belt attachment detector)
29 expansion/contraction sensor (belt expansion/contraction detector)
30 vibration sensor (cart body state detector)
31 warning lamp (warning unit)
35 belt
35A luggage
51 seating plate
100, 200 handcart
110 main body unit
111 auxiliary support
112 main wheel
113 auxiliary wheel
114 grip unit
115 support plate (loading platform)
201 main body unit
202 main wheel
203 support
204 grip unit
205 manual brake
211 controller
212 ROM
213 RAM
214 Gyro sensor
215 main-body-unit driver
216 main-wheel driver
261 camera
262 acceleration sensor
263 range sensor

1. A handcart comprising:
a main body unit;
at least one wheel provided to the main body unit,
a grip that is provided to the main body unit and gripped by a user;
a gripping sensor that detects whether the user is gripping the grip;
a cart body state sensor that detects a state of a cart body; and
a wheel controller that controls rotation of the wheel,
wherein the wheel controller locks the wheel, or restrains rotation of the wheel to decelerate the cart body, if the gripping sensor does not detect user's gripping of the grip and the cart body state sensor detects a predetermined cart body state.

2. The handcart according to claim 1,
wherein the predetermined cart body state comprises movement of the cart body,
wherein the cart body state sensor detects the movement of the cart body, and
wherein the wheel controller locks the wheel or restrains rotation of the wheel if an amount of movement detected by the cart body state sensor exceeds a predetermined value.

3. The handcart according to claim 2,
wherein if the cart body state sensor detects the movement of the cart body, the wheel controller locks the wheel after restraining rotation of the wheel.

4. The handcart according to claim 1,
wherein the cart body state sensor detects an acceleration of the cart body, and
wherein the wheel controller locks the wheel or restrains rotation of the wheel if the acceleration detected by the cart body state sensor is equal to or greater than a predetermined value.

5. The handcart according to claim 1,
wherein the cart body state sensor detects a speed of the cart body, and
wherein the wheel controller locks the wheel or restrains rotation of the wheel if the speed detected by the cart body state sensor is equal to or greater than a predetermined value.

6. The handcart according to claim 1,
wherein the cart body state sensor detects a distance moved by the cart body, and
wherein the wheel controller locks the wheel or restrains rotation of the wheel if the distance moved detected by the cart body state sensor is equal to or greater than a predetermined value.

7. The handcart according to claim 1,
wherein the at least one wheel comprises a pair of wheels, and
wherein the cart body state sensor calculates a difference in amount of rotation between the wheels, and if the difference exceeds a threshold, the wheel controller locks the wheels or restrains rotation of the wheels.

8. The handcart according to claim 1,
wherein the cart body state sensor detects a tilt angle of the cart body, and
wherein the wheel controller locks the wheel or restrains rotation of the wheel if the tilt angle detected by the cart body state sensor is equal to or greater than a predetermined value.

9. The handcart according to claim 1,
wherein the cart body state sensor includes an imaging unit that captures an image of surroundings,
wherein the cart body state sensor detects a situation in surroundings of the cart body based on the image of surroundings captured by the imaging unit, and
wherein the wheel controller locks the wheel or restrains rotation of the wheel if the cart body state sensor detects a predetermined situation in surroundings of the cart body.

10. The handcart according to claim 9,
wherein the wheel controller locks the wheel or restrains rotation of the wheel if the cart body state sensor detects that an amount of change between images of surroundings captured by the imaging unit at different times is equal to or greater than a predetermined value.

11. The handcart according to claim 1,
wherein the cart body state sensor detects vibration of the cart body, and
wherein the wheel controller locks the wheel or restrains rotation of the wheel if a magnitude of the vibration detected by the cart body state sensor exceeds a predetermined value.

12. The handcart according to claim 1, further comprising
a loading platform,
wherein the cart body state sensor includes a belt attachment sensor that detects whether a belt used to secure luggage placed on the loading platform is attached, and
wherein the wheel controller locks the wheel or restrains rotation of the wheel if the belt attachment sensor detects that the belt is not attached.

13. The handcart according to claim 1, further comprising
a loading platform,
wherein the cart body state sensor includes a belt expansion/contraction sensor that detects expansion/contraction of a belt used to secure luggage placed on the loading platform, and
wherein the wheel controller locks the wheel or restrains rotation of the wheel if an extent of expansion/contraction of the belt detected by the belt expansion/contraction sensor exceeds a predetermined value.

14. The handcart according to claim 1, further comprising
a warning unit that warns that the wheel has been locked or rotation of the wheel has been restrained by the wheel controller.

15. The handcart according to claim 2,
wherein the cart body state sensor detects an acceleration of the cart body, and
wherein the wheel controller locks the wheel or restrains rotation of the wheel if the acceleration detected by the cart body state sensor is equal to or greater than a predetermined value.

16. The handcart according to claim 2,
wherein the cart body state sensor detects a speed of the cart body, and
wherein the wheel controller locks the wheel or restrains rotation of the wheel if the speed detected by the cart body state sensor is equal to or greater than a predetermined value.

17. The handcart according to claim 2,
wherein the cart body state sensor detects a distance moved by the cart body, and
wherein the wheel controller locks the wheel or restrains rotation of the wheel if the distance moved detected by the cart body state sensor is equal to or greater than a predetermined value.

18. The handcart according to claim 2,
wherein the at least one wheel comprises a pair of wheels, and
wherein the cart body state sensor calculates a difference in amount of rotation between the wheels, and if the difference exceeds a threshold, the wheel controller locks the wheels or restrains rotation of the wheels.

19. The handcart according to claim 2,
wherein the cart body state sensor detects a tilt angle of the cart body, and
wherein the wheel controller locks the wheel or restrains rotation of the wheel if the tilt angle detected by the cart body state sensor is equal to or greater than a predetermined value.

20. The handcart according to claim 2,
wherein the cart body state sensor includes an imaging unit that captures an image of surroundings,
wherein the cart body state sensor detects a situation in surroundings of the cart body based on the image of surroundings captured by the imaging unit, and
wherein the wheel controller locks the wheel or restrains rotation of the wheel if the cart body state sensor detects a predetermined situation in surroundings of the cart body.
